(19) United States
(12) Patent Application Publication
(10) Pub. No.: US 2018/0210747 A1
(43) Pub. Date: Jul. 26, 2018

(54) COMPUTING DEVICES

(71) Applicant: P4TENTS1, LLC, Los Altos, CA (US)

(72) Inventors: Michael S Smith, Palo Alto, CA (US); Moon Ju Kim, Palo Alto, CA (US)

(21) Appl. No.: 15/927,070

(22) Filed: Mar. 20, 2018

Related U.S. Application Data
(63) Continuation-in-part of application No. 14/963,157, filed on Dec. 8, 2015, now abandoned.
(60) Provisional application No. 62/633,055, filed on Feb. 20, 2018.
(60) Provisional application No. 62/089,159, filed on Dec. 8, 2014.

(51) Int. Cl. G06F 9/455; G06F 15/16

(52) U.S. Cl. CPC G06F 9/45541; G06F 2009/45583; G06F 9/45558; G06F 15/16

(57) ABSTRACT

A system, method, and computer program product are provided for a processing unit including a plurality of processing cores including a first processing core and a second processing core. In use, the processing unit is configured such that a virtual processing core is capable of being virtualized utilizing at least a portion of the first processing core and at least a portion of the second processing core. Such virtualization is further carried out such that at least one of the at least portion of the first processing core or the at least portion of the second processing core includes only a part thereof.

### CROSS-REFERENCE TO RELATED APPLICATIONS

The present application is a continuation-in-part of and claims priority to U.S. patent application Ser. No. 14/963,157 that was filed Dec. 8, 2015 and entitled “COMPUTING DEVICES,” which claims priority to U.S. Prov. App. No. 62/089,159 that was filed Dec. 8, 2014 and entitled “COMPUTING DEVICES,” which is incorporated herein by reference in its entirety for all purposes. If any definitions (e.g. figure reference signs, specialized terms, examples, data, information, definitions, conventions, glossary, etc.) from any related material (e.g. parent application, other related application, material incorporated by reference, material cited, extrinsic reference, etc.) conflict with this application (e.g. abstract, description, summary, claims, etc.) for any purpose (e.g. prosecution, claim support, claim interpretation, claim construction, etc.), then the definitions in this application shall apply. The present application also claims priority to U.S. Prov. App. No. 62/633,055 that was filed Feb. 20, 2018 and entitled “COMPUTING DEVICES,” which is incorporated herein by reference in its entirety for all purposes.

### CROSS-REFERENCE TO RELATED APPLICATIONS

If any definitions (e.g. figure reference signs, specialized terms, examples, data, information, definitions, conventions, glossary, etc.) from any related material (e.g. parent application, other related application, material incorporated by reference, material cited, extrinsic reference, etc.) conflict with this application (e.g. abstract, description, summary, claims, etc.) for any purpose (e.g. prosecution, claim support, claim interpretation, claim construction, etc.), then the definitions in this application shall apply.

### FIELD OF THE INVENTION AND BACKGROUND

Embodiments of the present invention generally relate to improvements to computing devices and, more specifically, to efficient use of CPUs in various devices.

### BRIEF SUMMARY

A system, method, and computer program product are provided for a processing unit including a plurality of processing cores including a first processing core and a second processing core. In use, the processing unit is configured such that a virtual processing core is capable of being virtualized utilizing at least a portion of the first processing core and at least a portion of the second processing core. Such virtualization is further carried out such that at least one of the at least portion of the first processing core or the at least portion of the second processing core includes only a part thereof.

### BRIEF DESCRIPTION OF THE SEVERAL VIEWS OF THE DRAWINGS

So that the features of various embodiments of the present invention can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the various embodiments of the invention, for the embodiment(s) may admit to other effective embodiments. The following detailed description makes reference to the accompanying drawings that are now briefly described.

FIG. 10-1 shows a system, in accordance with one embodiment.

FIG. 10-2 shows a system, in accordance with one embodiment.

FIG. 10-3 shows a system, in accordance with one embodiment.

FIG. 10-4 shows a system, in accordance with one embodiment.

FIG. 10-5 shows a system, in accordance with one embodiment.

While one or more of the various embodiments of the invention is susceptible to various modifications, combinations, and alternative forms, various embodiments thereof are shown by way of example in the drawings and will herein be described in detail. It should be understood, however, that the accompanying drawings and detailed description are not intended to limit the embodiment(s) to the particular form disclosed, but on the contrary, the intention is to cover all modifications, combinations, equivalents and alternatives falling within the spirit and scope of the various embodiments of the present invention as defined by the relevant claims.

### DETAILED DESCRIPTION

### Glossary, Conventions, Terms and Definitions

This section may include terms and definitions that may be applicable to all embodiments described in this specification and/or described in specifications incorporated by reference. Terms that may be special to the field of the various embodiments of the invention or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization and/or use of other conventions, styles, formats, etc. by itself, should not be construed as somehow limiting such terms: beyond any given definition, and/or to any specific embodiments disclosed herein, etc.

In this description a device (e.g. a mobile device, electronic system, machine, and/or any type of apparatus, system, mote, that may be mobile, fixed, wearable, portable, integrated, cloud-based, distributed and/or any combination of these and which may be formed, manufactured, operated, etc. in any fashion, manner, location(s) etc.) may be used as an example. It should be understood, however, that one or more of the embodiments described herein and/or in one or more specifications incorporated by reference may be applied to any device(s) or similar object(s) e.g. consumer devices, phones, phone systems, cell phones, cellular phones, mobile phone, smart phone, internet phones, wireless phones, personal digital assistants (PDAs), remote communication devices, wireless devices, music players, video players, media players, multimedia players, video recorders, VCRs, DVRs, book readers, voice recorders, voice controlled systems, voice controllers, cameras, social interaction devices, radios, TVs, watches, personal communication devices, electronic wallets, electronic currency, smart cards, smart credit cards, electronic money, electronic coins, electronic tokens, smart jewelry, electronic passports, electronic identification systems, biometric sensors, biometric systems, biometric devices, smart pens, smart rings, personal computers, tablets, laptop computers, scanners, printers, computers, web servers, media servers, multimedia servers, file servers, datacenter servers, database servers, database appliances, cloud servers, cloud devices, cloud appliances, embedded systems, embedded devices, electronic glasses, electronic goggles, electronic screens, displays, wearable displays, projectors, picture frames, touch screens, computer appliances, kitchen appliances, home appliances, home theater systems, audio systems, home control appliances, home control systems, irrigation systems, sprinkler systems, garage door systems, garage door controls, remote controls, remote control systems, thermostats, heating systems, air conditioning systems, ventilation systems, climate control systems, climate monitoring systems, industrial control systems, transportation systems and controls, industrial process and control systems, industrial controller systems, machine-to-machine systems, aviation systems, locomotive systems, power control systems, power controllers, lighting control, lights, lighting systems, solar system controllers, solar panels, vehicle and other engines, engine controllers, motors, motor controllers, navigation controls, navigation systems, navigation displays, sensors, sensor systems, transducers, transducer systems, computer input devices, device controllers, touchpads, mouse, pointer, joystick, keyboards, game controllers, haptic devices, game consoles, game boxes, network devices, routers, switches, TiVO, AppleTV, GoogleTV, internet TV boxes, internet systems, internet devices, set-top boxes, cable boxes, modems, cable modems, PCs, tablets, media boxes, streaming devices, entertainment centers, entertainment systems, aircraft entertainment systems, hotel entertainment systems, car and vehicle entertainment systems, GPS devices, GPS systems, automobile and other motor vehicle systems, truck systems, vehicle control systems, vehicle sensors, aircraft systems, automation systems, home automation systems, industrial automation systems, reservation systems, check-in terminals, ticket collection systems, admission systems, payment devices, payment systems, banking machines, cash points, ATMs, vending machines, vending systems, point of sale devices, coin-operated devices, token operated devices, gas (petrol) pumps, ticket machines, toll systems, barcode scanners, credit card scanners, travel token systems, travel card systems, RFID devices, electronic labels, electronic tags, tracking systems, electronic stickers, electronic price tags, near field communication (NFC) devices, wireless operated devices, wireless receivers, wireless transmitters, sensor devices, motes, sales terminals, checkout terminals, electronic toys, toy systems, gaming systems, information appliances, information and other kiosks, sales displays, sales devices, electronic menus, coupon systems, shop displays, street displays, electronic advertising systems, traffic control systems, traffic signs, parking systems, parking garage devices, elevators and elevator systems, building systems, mailboxes, electronic signs, video cameras, security systems, surveillance systems, electronic locks, electronic keys, electronic key fobs, access devices, access controls, electronic actuators, safety systems, smoke detectors, fire control systems, fire detection systems, locking devices, electronic safes, electronic doors, music devices, storage devices, back-up devices, USB keys, portable disks, exercise machines, sports equipment, medical devices, medical systems, personal medical devices, wearable medical devices, portable medical devices, mobile medical devices, blood pressure sensors, heart rate monitors, blood sugar monitors, vital sign monitors, ultrasound devices, medical imagers, drug delivery systems, drug monitoring systems, patient monitoring systems, medical records systems, industrial monitoring systems, robots, robotic devices, home robots, industrial robots, electric tools, power tools, construction equipment, electronic jewelry, wearable devices, wearable electronic devices, wearable cameras, wearable video cameras, wearable systems, electronic dispensing systems, handheld computing devices, handheld electronic devices, electronic clothing, combinations of these and/or any other devices, multi-function devices, multi-purpose devices, combination devices, cooperating devices, and the like, etc.

The devices may support (e.g. include, comprise, contain, implement, execute, be part of, be operable to execute, display, source, provide, store, etc.) one or more applications and/or functions e.g. search applications, contacts and/or friends applications, social interaction applications, social media applications, messaging applications, telephone applications, video conferencing applications, e-mail applications, voicemail applications, communications applications, voice recognition applications, instant messaging (IM) applications, texting applications, blog and/or blogging applications, photographic applications (e.g. catalog, management, upload, editing, etc.), shopping, advertising, sales, purchasing, selling, vending, ticketing, payment, digital camera applications, digital video camera applications, web browsing and browser applications, digital music player applications, digital video player applications, cloud applications, office productivity applications, database applications, cataloging applications, inventory control, medical applications, electronic book and newspaper applications, travel applications, dictionary and other reference work applications, language translation, spreadsheet applications, word processing applications, presentation applications, business applications, finance applications, accounting applications, publishing applications, web authoring applications, multimedia editing, computer-aided design (CAD), manufacturing applications, home automation and control, backup and/or storage applications, help and/or manuals, banking applications, stock trading applications, calendar applications, voice driven applications, map applications, consumer entertainment applications, games, other applications and/or combinations of these and/or multiple instances (e.g. versions, copies, etc.) of these and/or other applications, and the like etc.

The devices may include (e.g. comprise, be capable of including, have features to include, have attachments, communicate with, be linked to, be coupled with, operable to be coupled with, be connected to, be operable to connect to, etc.) one or more devices e.g. there may be a hierarchy of devices, nested devices, etc.). The devices may operate, function, run, etc. as separate components, working in cooperation, as a cooperative hive, as a confederation of devices, as a federation, as a collection of devices, as a cluster, as a multi-function device, with sockets, ports, connectivity, etc. for extra, additional, add-on, optional, etc. devices and/or components, attached devices (e.g. direct attach, network attached, remote attach, cloud attach, add on, plug in, etc.), upgrade components, helper devices, acceleration devices, support devices, engines, expansion devices and/or modules, combinations of these and/or other components, hardware, software, firmware, devices, and the like etc.

The devices may have (e.g. comprise, include, execute, perform, capable of being programmed to perform, etc.) one or more device functions (e.g. telephone, video conferencing, e-mail, instant messaging, blogging, digital photography, digital video, web browsing, digital music playing, social interaction, shopping, searching, banking, combinations of these and/or other functions, and the like etc.). Instructions, help, guides, manuals, procedures, algorithms, processes, methods, techniques, etc. for performing and/or helping to perform etc. the device functions etc. may be included in a computer readable storage medium, computer readable memory medium, or other computer program product configured for execution, for example, by one or more processors.

The devices may include one or more processors (e.g. central processing units, CPUs, multicore CPUs, homogeneous CPUs, heterogeneous CPUs, graphics processing units, GPUs, computing arrays, CPU arrays, microprocessors, controllers, microcontrollers, engines, accelerators, compute arrays, programmable logic, DSP, combinations of these and the like etc.). Devices and/or processors etc. may include, contain, comprise, etc. one or more operating systems (OSs). Processors may use one or more machine or system architectures (e.g. ARM, Intel, x86, hybrids, emulators, other architectures, combinations of these, and the like etc.).

Processor architectures may use one or more privilege levels. For example, the x86 architecture may include four hardware resource privilege levels or rings. The OS kernel, for example, may run in privilege level 0 or ring 0 with complete control over the machine or system. In the Linux OS, for example, ring 0 may be kernel space, and user mode may run in ring 3.

A multi-core processor (multicore processor, multicore CPU, etc.) may be a single computing component (e.g. a single chip, a single logical component, a single physical component, a single package, an integrated circuit, a multi-chip package, combinations of these and the like etc.). A multicore processor may include (e.g. comprise, contain, etc.) two or more central processing units etc. called cores. The cores may be independent, relatively independent and/or connected, coupled, integrated, logically connected etc. in any way. The cores, for example, may be the units that read and execute program instructions. The instructions may be ordinary CPU instructions such as add, move data, and branch, but the multiple cores may run multiple instructions at the same time, increasing overall speed, for example, for programs amenable to parallel computing. Manufacturers may typically integrate the cores onto a single integrated circuit die (known as a chip multiprocessor or CMP), or onto multiple dies in a single chip package, but any implementation, construction, assembly, manufacture, packaging method and/or process etc. is possible.

The devices may use one or more virtualization methods. Virtualization, in computing, refers to the act of creating (e.g. simulating, emulating, etc.) a virtual (rather than actual) version of something, including but not limited to a virtual computer hardware platform, operating system (OS), storage device, computer network resources and the like.

For example, a hypervisor or virtual machine monitor (VMM) may be a virtualization method and may allow (e.g. permit, implement, etc.) hardware virtualization. A hypervisor may run (e.g. execute, operate, control, etc.) one or more operating systems (e.g. guest OSs, etc.) simultaneously (e.g. concurrently, at the same time, at nearly the same time, in a time multiplexed fashion, etc.), each may run on its own virtual machine (VM) on a host machine and/or host hardware (e.g. device, combination of devices, combinations of devices with other computer(s), etc.). A hypervisor, for example, may run at a higher level than a supervisor.

Multiple instances of OSs may share virtualized hardware resources. A hypervisor, for example, may present a virtual platform, architecture, design, etc. to a guest OS and may monitor the execution of one or more guest OSs. A Type 1 hypervisor (also type I, native, or bare metal hypervisor, etc.) may run directly on the host hardware to control the hardware and monitor guest OSs. A guest OS thus may run at a level above (e.g. logically above, etc.) a hypervisor. Examples of Type 1 hypervisors may include VMware ESXi, Citrix XenServer, Microsoft Hyper-V, etc. A Type 2 hypervisor (also type II, or hosted hypervisor) may run within a conventional OS (e.g. Linux, Windows, Apple iOS, etc.). A Type 2 hypervisor may run at a second level (e.g. logical level, etc.) above the hardware. Guest OSs may run at a third level above a Type 2 hypervisor. Examples of Type 2 hypervisors may include VMware Server, Linux KVM, VirtualBox, etc. A hypervisor thus may run one or more other hypervisors with their associated VMs. In some cases, virtualization and nested virtualization may be part of an OS. For example, Microsoft Windows 7 may run Windows XP in a VM. For example, the IBM turtles project, part of the Linux KVM hypervisor, may run multiple hypervisors (e.g., KVM and VMware, etc.) and operating systems (e.g. Linux and Windows, etc.). The term embedded hypervisor may refer to a form of hypervisor that may allow, for example, one or more applications to run above the embedded hypervisor without an OS.

The term hardware virtualization may refer to virtualization of machines, devices, computers, operating systems, combinations of these, etc. that may hide the physical aspects of a computer system and instead present (e.g. show, manifest, demonstrate, etc.) an abstract system (e.g. view, aspect, appearance, etc.). For example, x86 hardware virtualization may allow one or more OSs to share x86 processor resources in a secure, protected, safe, etc. manner. Initial versions of x86 hardware virtualization were implemented using software techniques to overcome the lack of processor virtualization support. Manufacturers (e.g. Intel, AMD, etc.) later added (e.g. in later generations, etc.) processor virtualization support to x86 processors, thus simplifying later versions of x86 virtualization software, etc. Continued addition of hardware virtualization features to x86 and other (e.g. ARM) processors has resulted in continued improvements (e.g. in speed, in performance, etc.) of hardware virtualization. Other virtualization methods, such as memory virtualization, I/O virtualization (IOV), etc. may be performed by a chipset, integrated with a CPU, and/or by other hardware components, etc. For example, an input/output memory management unit (IOMMU) may enable guest VMs to access peripheral devices (e.g. network adapters, graphics cards, storage controllers, etc.) e.g. using DMA, interrupt remapping, etc. For example, PCI-SIG IOV may use a set of general (e.g. non-x86 specific) PCI Express (PCI-E) based native hardware I/O virtualization techniques. For example, one such technique may be Address Translation Services (ATS) that may support native IOV across PCI-E using address translation. For example, Single Root IOV (SR-IOV) may support native IOV in single root complex PCI-E topologies. For example, Multi-Root IOV (MR-IOV) may support native IOV by expanding SR-IOV to provide multiple root complexes that may, for example, share a common PCI-E hierarchy. In SR-IOV, for example, a host VMM may configure supported devices to create and allocate virtual shadows of configuration spaces (e.g. shadow devices, etc.) so that VM guests may, for example, configure, access, etc. one or more shadow device resources.

The devices (e.g. device software, device firmware, device applications, OSs, combinations of these, etc.) may use one or more programs (e.g. source code, programming languages, binary code, machine code, applications, apps, functions, etc.). The programs etc. may use (e.g. require, employ, etc.) one or more code translation techniques (e.g. process, algorithms, etc.) to translate from one form of code to another form of code e.g. to translate from source code (e.g. readable text, abstract representations, high-level representations, graphical representations, etc.) to machine code (e.g. machine language, executable code, binary code, native code, low-level representations, etc.). For example, a compiler may translate (e.g. compile, transform, etc.) source code into object code (e.g. compiled code, etc.). For example, a linker may translate object code into machine code (e.g. linked code, loadable code, etc.). Machine code may be executed by a CPU etc. at runtime. Computer programming languages (e.g. high-level programming languages, source code, abstract representations, etc.) may be interpreted or compiled. Interpreted code may be translated (e.g. interpreted, by an interpreter, etc.), for example, to machine code during execution (e.g. at runtime, continuously, etc.). Compiled code may be translated (compiled, by a compiler, etc.), for example, to machine code once (e.g. statically, at one time, etc.) before execution. An interpreter may be classified into one or more of the following types: type 1 interpreters may, for example, execute source code directly; type 2 interpreters may, for example, compile or translate source code into an intermediate representation (e.g. intermediate code, intermediate language, temporary form, etc.) and may execute the intermediate code; type 3 interpreters may execute stored precompiled code generated by a compiler that may, for example, be part of the interpreter. For example, languages such as Lisp, etc. may use a type 1 interpreter; languages such as Perl, Python, etc. may use a type 2 interpreter; languages such as Pascal, Java, etc. may use a type 3 interpreter: Some languages, such as Smalltalk, BASIC, etc. may, for example, combine facets, features, properties, etc. of interpreters of type 2 and interpreters of type 3. There may not always, for example, be a clear distinction between interpreters and compilers. For example, interpreters may also perform some translation. For example, some programming languages may be both compiled and interpreted or may include features of both. For example, a compiler may translate source code into an intermediate form (e.g. bytecode, portable code, p-code, intermediate code, etc.), that may then be passed to an interpreter. The terms interpreted language or compiled language applied to, describing, classifying, etc. a programming language (e.g. C++ is a compiled programming language, etc.) may thus refer to an example (e.g. canonical, accepted, standard, theoretical, etc.) implementation of a programming language that may use an interpreter, compiler, etc. Thus a high-level computer programming language, for example, may be an abstract, ideal, theoretical, etc. representation that may be independent of a particular, specific, fixed, etc. implementation (e.g. independent of a compiled, interpreted version, etc.).

The devices (e.g. device software, device firmware, device applications, OSs, etc.) may use one or more alternative code forms, representations, etc. For example, a device may use bytecode that may be executed by an interpreter or that may be compiled. Bytecode may take any form. Bytecode may, for example, be based on (e.g. be similar to, use, etc.) hardware instructions and/or use hardware instructions in machine code. Bytecode design (e.g. format, architecture, syntax, appearance, semantics, etc.) may be based on a machine architecture (e.g. virtual stack machine, virtual register machine, etc.). Parts, portions, etc. of bytecode may be stored in files (e.g. modules, similar to object modules, etc.). Parts, portions, modules, etc. of bytecode may be dynamically loaded during execution. Intermediate code (e.g. bytecode, etc.) may be used to simplify and/or improve the performance, etc. of interpretation. Bytecode may be used, for example, in order to reduce hardware dependence, OS dependence, other dependencies, etc. by allowing the same bytecode to run on different platforms (e.g. architectures, etc.). Bytecode may be directly executed on a VM (e.g. using an interpreter, etc.). Bytecode may be translated (e.g. compiled, etc.) to machine code e.g. to improve performance, etc. Bytecode may include compact numeric codes, constants, references, numeric addresses, etc. that may encode the result of translation, parsing, semantic analysis etc. of the types, scopes, nesting depths, etc. of program objects, constructs, structures, etc. The use of bytecode may, for example, allow improved performance over the direct interpretation of source code. Bytecode may be executed, for example, by parsing and executing bytecode instructions e.g. one instruction at a time. A bytecode interpreter may be portable (e.g. independent of device, machine architecture, computer system, computing platform, etc.).

The devices (e.g. device applications, OSs, etc.) may use one or more VMs. For example, a Java Virtual Machine (JVM) may use Java bytecode as intermediate code. Java bytecode may correspond, for example, to the instruction set of a stack-oriented architecture. For example, Oracle's JVM is called HotSpot. Examples of clean-room Java implementations may include Kaffe, IBM J9, and Dalvik. A software library (library) may be a collection of related object code. A class may be a unit of code. The Java Classloader may be part of the Java Runtime Environment (JRE) that may, for example, dynamically load Java classes into the JVM. Java libraries may be packaged in Jar files. Libraries may include objects of different types. One type of object in a Jar file may be a Java class. The class loader may locate libraries, read library contents, and load classes included within the libraries. Loading may, for example, be performed on demand, when the class is required by a program. Java may make use of external libraries (e.g. libraries written and provided by a third party, etc.). When a JVM is started, one or more of the following class loaders may be used: 1. bootstrap class loader; 2. extensions class loader; 3. system class loader. The bootstrap class loader, which may be part of the core JVM for example, may be written in native code and may load the core Java libraries. The extensions class loader may, for example, load code in the extensions directories. The system class loader may, for example, load code on the java.class.path stored in the system CLASSPATH variable. By default, all user classes may, for example, be loaded by the default system class loader that may be replaced by a user-defined ClassLoader. The Java Class Library may be a set of dynamically loadable libraries that Java applications may call at runtime. Because the Java Platform may be independent of any OS, the Java Platform may provide a set of standard class libraries that may, for example, include reusable functions commonly found in an OS. The Java Class Library may be almost entirely written in Java, except, for example, for some parts that may need direct access to hardware, OS functions, etc. (e.g. for I/O, graphics, etc.). The Java classes that may provide access to these functions may, for example, use native interface wrappers, code fragments, etc. to access the API of the OS. Almost all of the Java Class Library may, for example, be stored in a Java archive file rt.jar, which may be provided with JRE and JDK distributions, for example.

The devices (e.g. device applications, OSs, etc.) may use one or more alternative code translation methods. For example, some code translation systems e.g. dynamic translators, just-in-time (JIT) compilers, etc. may translate bytecode into machine language (e.g. native code, etc.) on demand, as required, etc. at runtime. Thus, for example, source code may be compiled and stored as machine independent code. The machine independent code may be linked at run time and may, for example, be executed by an interpreter, compiler for JIT systems, etc. This type of translation, for example, may reduce portability, but may not reduce the portability of the bytecode itself. For example, programs may be stored in bytecode that may then be compiled using a JIT compiler that may translate bytecode to machine code. This may add a delay before a program runs but may, for example, improve execution speed relative to the direct interpretation of source code. Translation may, for example, be performed in one or more phases. For example, a first phase may compile source code to bytecode, and a second phase may translate the bytecode to a VM. There may be different VMs for different languages, representations, etc. (e.g. for Java, Python, PHP, Forth, Tcl, etc.). For example, Dalvik bytecode designed for the Android platform, for example, may be executed by the Dalvik VM. For example, the Dalvik VM may use special representations (e.g. DEX, etc.) for storing applications. For example, the Dalvik VM may use its own instruction set (e.g. based on a register-based architecture rather than stack-based architecture, etc.) rather than standard JVM bytecode, etc. Other implementations may be used. For example, the implementation of Perl, Ruby, etc. may use an abstract syntax tree (AST) representation that may be derived from the source code. For example, ActionScript (an object-oriented language that may be a superset of JavaScript, a scripting language) may execute in an ActionScript Virtual Machine (AVM) that may be part of Flash Player and Adobe Integrated Runtime (AIR). ActionScript code, for example, may be transformed into bytecode by a compiler. ActionScript compilers may be used, for example, in Adobe Flash Professional and in Adobe Flash Builder and may be available as part of the Adobe Flex SDK. A JVM may contain both and interpreter and JIT compiler and switch from interpretation to compilation for frequently executed code. One form of JIT compiler may, for example, represent a hybrid approach between interpreted and compiled code, and translation may occur continuously (e.g. as with interpreted code), but caching of translated code may be used e.g. to increase speed, performance, etc. JIT compilation may also offer advantages over static compiled code, e.g. the use late-bound data types, the ability to use and enforce security constraints, etc. JIT compilation may, for example, combine bytecode compilation and dynamic compilation. JIT compilation may, for example, convert code at runtime prior to executing it natively e.g. by converting bytecode into native machine code. Several runtime environments, (e.g. Microsoft .NET Framework, some implementations of Java, etc.) may, for example, use, employ, depend on, etc. JIT compilers. This specification may avoid the use of the term native machine code to avoid confusion with the terms machine code and native code.

The devices (e.g. device applications, OSs, etc.) may use one or more methods of emulation, simulation, etc. For example, binary translation may refer to the emulation of a first instruction set by a second instruction set e.g. using code translation. For example, instructions may be translated from a source instruction set to a target instruction set. In some cases, such as instruction set simulation, the target instruction set may be the same as the source instruction set, and may, for example, provide testing features, debugging features, instruction trace, conditional breakpoints, hot spot detection, etc. Binary translation may be further divided into static binary translation and dynamic binary translation. Static binary translation may, for example, convert the code of an executable file to code that may run on a target architecture without, for example, having to run the code first. In dynamic binary translation, for example, the code may be run before conversion. In some cases conversion may not be direct since not all the code may be discoverable (e.g. reachable, etc.) by the translator. For example, parts of executable code may only be reached through indirect branches, with values, state, etc. needed for translation that may be known only at run-time. Dynamic binary translation may parse (e.g. process, read, etc.) a short sequence of code, may translate that code, and may cache the result of the translation. Other code may be translated as the code is discovered and/or when it is possible to be discovered. Branch instructions may point to already translated code and/or saved and/or cached (e.g. using memorization, etc.). Dynamic binary translation may differ from emulation and may eliminate the loop formed by the emulator reading, decoding, executing etc. Binary translation may, for example, add a potential disadvantage of requiring additional translation overhead. The additional translation overhead may be reduced, ameliorated, etc. as translated code is repeated, executed multiple times, etc. For example, dynamic translators (e.g. Sun/Oracle HotSpot, etc.) may use dynamic recompilation etc. to monitor translated code and aggressively (e.g. continuously, repeatedly, in an optimized fashion, etc.) optimize code that may be frequently executed, repeatedly executed, etc. This and other optimization techniques may be similar to that of a JIT compiler, and such compilers may be viewed as performing dynamic translation from a virtual instruction set (e.g. using bytecode, etc.) to a physical instruction set.

The term virtualization may refer to the creation (e.g. generation, design, etc.) of a virtual version (e.g. abstract version, apparent version, appearance of, illusion rather than actual, non-tangible object, etc.) of something (e.g. an object, tangible object, etc.) that may be real (e.g. tangible, non-abstract, physical, actual, etc.). For example, virtualization may apply to a device, mobile device, computer system, machine, server, hardware platform, platform, PC, tablet, operating system (OS), storage device, network resource, software, firmware, combinations of these and/or other objects, etc. For example, a VM may provide, present, etc. a virtual version of a real machine and may run (e.g. execute, etc.) a host OS, other software, etc. A VMM may be software (e.g. monitor, controller, supervisor, etc.) that may allow one or more VMs to run (e.g. be multiplexed, etc.) on one real machine. A hypervisor may be similar to a VMM. A hypervisor, for example, may be higher in functional hierarchy (e.g. logically, etc.) than a supervisor and may, for example, manage multiple supervisors (e.g. kernels, etc.). A domain (also logical domain, etc.) may run in (e.g. execute on, be loaded to, be joined with, etc.) a VM. The relationship between VMs and domains, for example, may be similar to that between programs and processes (or threads, etc.) in an OS. A VM may be a persistent (e.g. non-volatile, stored, permanent, etc.) entity that may reside (e.g. be stored, etc.) on disk and/or other storage, loaded into memory, etc. (e.g. and be analogous to a program, application, software, etc.). Each domain may have a domain identifier (also domain ID) that may be a unique identifier for a domain, and may be analogous (e.g. equivalent, etc.), for example, to a process ID in an OS. The term live migration may be a technique that may move a running (e.g. executing, live, operational, functional, etc.) VM to another physical host (e.g. machine, system, device, etc.), without stopping (e.g. halting, terminating, etc.) the VM and/or stopping any services, processes, threads, etc. that may be running on the VM.

Different types of hardware virtualization may include:

1. Full virtualization: Complete or almost complete simulation of actual hardware to allow software, which may and typically consists of a guest operating system, to run unmodified. A VM may be (e.g. appear to be, etc.) identical (e.g. equivalent to, etc.) to the underlying hardware in full virtualization.

2. Partial virtualization: Some but not all of the target environment may be simulated. Some guest programs, therefore, may need modifications to run in this type of virtual environment.

3. Paravirtualization: A hardware environment is not necessarily simulated; however, the guest programs may be executed in their own isolated domains, as if they are running on a separate system. Guest programs may need to be specifically modified to run in this type of environment. A VM may differ (e.g. in appearance, in functionality, in behavior, etc.) from the underlying (e.g. native, real, etc.) hardware in paravirtualization.

There may be other differences between these different types of hardware virtualization environments. Full virtualization may not require modifications (e.g. changes, alterations, etc.) to the host OS and may abstract (e.g. virtualize, hide, obscure, etc.) underlying hardware. Paravirtualization may also require modifications to the host OS in order to run in a VM. In full virtualization, for example: privileged instructions and/or other system operations etc. may be handled by the hypervisor with other instructions running on native hardware. In paravirtualization, for example, code may be modified e.g. at compile-time, run-time, etc. For example, in paravirtualization privileged instructions may be removed, modified, etc. and, for example, replaced with calls to a hypervisor e.g. using APIs, hypercalls, etc. For example, Xen may be an example of an OS that may use paravirtualization, but may preserve binary compatibility for user-space applications, etc.

Virtualization may be applied to an entire OS and/or parts of an OS. For example, a kernel may be a main (e.g. basic, essential, key, etc.) software component of an OS. A kernel may form a bridge (e.g. link, coupling, layer, conduit, etc.) between applications (e.g. software, programs, etc.) and underlying hardware, firmware, software, etc. A kernel may, for example, manage, control, etc. one or more (including all) system resources e.g. CPUs, processors, I/O devices, interrupt controllers, timers, etc. A kernel may, for example, provide a low-level abstraction layer for the system resources that applications may control, manage, etc. A kernel running, for example, at the highest hardware privilege level may make system resources available to user-space applications through inter-process communication (IPC) mechanisms, system calls, etc. A microkernel may, for example, be a smaller (e.g. smaller than a kernel, etc.) OS software component. In a microkernel the majority of the kernel code may be implemented, for example, in a set of kernel servers (also just servers) that may communicate through a small kernel, using a small amount of code running in system (e.g. kernel) space and the majority of code in user space. A microkernel may, for example, consist of a simple (e.g. relative to a kernel, etc.) abstraction over (e.g. logically above, etc.) underlying hardware, with a set of primitives, system calls, other code, etc. that may implement basic (e.g. minimal, key, etc.) OS services (e.g. memory management, multitasking, IPC, etc.). Other OS services, (e.g. networking, storage drivers, high-level functions, etc.) may be implemented, for example, in one or more kernel servers. An exokernel may, for example, be similar to a microkernel but may provide a more hardware-like interface e.g. more direct interface, etc. For example, an exokernel may be similar to a paravirtualizing VMM (e.g. Xen, etc.), but an exokernel may be designed as a distinct and separate OS structure, rather than to run multiple conventional OSs. A nanokernel may, for example, delegate (e.g. assign, etc.) virtually all services (e.g. including interrupt controllers, timers, etc.), for example to device drivers. The term operating system-level virtualization (also OS virtualization, container, virtual private server, VPS, virtual environment, VE, jail, etc.) may refer to a server virtualization technique. In OS virtualization, for example, the kernel of an OS may allow (e.g. permit, enable, implement, etc.) one or more isolated user-space instances or containers. For example, a container may appear to be a real server from the view of a user. For example, a container may be based on standard Linux chroot techniques. In addition to isolation, a kernel may control (e.g. limit, stop, regulate, manage, prevent, etc.) interaction between containers.

Virtualization may be applied to one or more hardware components. For example, VMs may include one or more virtual components. The hardware components and/or virtual components may be inside (e.g. included within, part of, etc.) or outside (e.g. connected to, external to, etc.) a CPU, may be part of or include parts of a memory system and/or sub-system, or may be any part or parts of a system, device, or may be any combinations of such parts and the like, etc. A memory page (also virtual page, or just page) may, for example, be a contiguous block of virtual memory of fixed-length that may be the smallest unit used for (e.g. granularity of, etc.) memory allocation performed by the OS e.g. for a program, etc. A page table may be a data structure, hardware component, etc. used, for example, by a virtual memory system in an OS to store the mapping from virtual addresses to physical addresses. A memory management unit (MMU) may, for example, store a cache of memory mappings from the OS page table in a translation lookaside buffer (TLB). A shadow page table may be a component that is used, for example, by a technique to abstract memory layout from a VM OS. For example, one or more shadow page tables may be used in a VMM to provide an abstraction of (e.g. an appearance of, a view of, etc.) contiguous physical memory. A CPU may include one or more CPU components, circuit, blocks, etc. that may include one or more of the following, but not limited to the following: caches, TLBs, MMUs, page tables, etc. at one or more levels (e.g. L1, L2, L3, etc.). A CPU may include one or more shadow copies of one or more CPU components etc. One or more shadow page tables may be used, for example, during live migration. One or more virtual devices may include one or more physical system hardware components (e.g. CPU, memory, I/O devices, etc.) that may be virtualized (e.g. abstracted, etc.) by, for example, a hypervisor and presented to one or more domains. In this description the term virtual device, for example, may also apply to virtualization of a device (and/or part(s), portion(s) of a device, etc.) such as a mobile phone or other mobile device, electronic system, appliance, etc. A virtual device may, for example, also apply to (e.g. correspond to, represent, be equivalent to, etc.) virtualization of a collection, set, group, etc. of devices and/or other hardware components, etc.

Virtualization may be applied to I/O hardware, one or more I/O devices (e.g. storage devices, cameras, graphics cards, input devices, printers, network interface cards, etc.), I/O device resources, etc. For example, an IOMMU may be a MMU that connects one or more I/O devices on one or more I/O buses to the memory system. The IOMMU may, for example, map (e.g. translate, etc.) I/O device virtual addresses (e.g. device addresses, I/O addresses, etc.) to physical addresses. The IOMMU may also include memory protection (e.g. preventing and/or controlling unauthorized access to I/O devices, I/O device resources, etc.), one or more memory protection tables, etc. The IOMMU may, for example, also allow (e.g. control, manage, etc.) direct memory access (DMA) and allow (e.g. enable, etc.) one or more VMs etc. to access DMA hardware.

Virtualization may be applied to software (e.g. applications, programs, etc.). For example, the term application virtualization may refer to techniques that may provide one or more application features. For example, application virtualization may isolate (e.g. protect, separate, divide, insulate, etc.) applications from the underlying OS and/or from other applications. Application virtualization may, for example, enable (e.g. allow, permit, etc.) applications to be copied (e.g. streamed, transferred, pulled, pushed, sent, distributed, etc.) from a source (e.g. centralized location, control center, datacenter server, cloud server, home PC, manufacturer, distributor, licensor, etc.) to one or more target devices (e.g. user devices, mobile devices, clients, etc.). For example, application virtualization may allow (e.g. permit, enable, etc.) the creation of an isolated (e.g. a protected, a safe, an insulated, etc.) environment on a target device. A virtualized application may not necessarily be installed in a conventional (e.g. usual, normal, etc.) manner. For example, a virtualized application (e.g. files, configuration, settings, etc.) may be copied (e.g. streamed, distributed, etc.) to a target (e.g. destination, etc.) device rather than being installed etc. The execution of a virtualized application at run time may, for example, be controlled by an application virtualization layer. A virtualized application may, for example, appear to interface directly with the OS, but may actually interface with the virtualization environment. For example, the virtualization environment may proxy (e.g. intercept, forward, manage, control, etc.) one or more (including all) OS requests. The term application streaming may refer, for example, to virtualized application techniques that may use pieces (e.g. parts, portions, etc.) of one or more applications (e.g. code, data, settings, etc.) that may be copied (e.g. streamed, transferred, downloaded, uploaded, moved, pushed, pulled, etc.) to a target device. A software collection (e.g. set, distribution, distro, bundle, package, etc.) may, for example, be a set of software components built, assembled, configured, and ready for use, execution, installation, etc. Applications may be streamed, for example, as one or more collections. Application streaming may, for example, be performed on demand (e.g. as required, etc.) instead of copying or installing an entire application before startup. In some cases a streamed application may, for example, require the installation of a lightweight application on a target device. A streamed application and/or application collections may, for example, be delivered using one or more networking protocols (e.g. HTTP, HTTPS, CIFS, SMB, RTSP, etc.). The term desktop virtualization (also virtual desktop infrastructure, VDI, etc.) may refer, for example, to an application that may be hosted in a VM (or blade PC, appliance, etc.) and that may also include an OS. VDI techniques may, for example, include control of (e.g. management infrastructure for, automated creation of, etc.) one or more virtual desktops. The term session virtualization may refer, for example, to techniques that may use application streaming to deliver applications to one or more hosting servers (e.g. in a remote datacenter, cloud server, cloud service, etc.). The application may then, for example, execute on the hosting server(s). A user may then, for example, connect to (e.g. login, access, etc.) the application, hosting server(s), etc. The user and/or user device may, for example, send input (e.g. mouse-click, keystroke, mouse or other pointer location, audio, video, location, sensor data, control data, combinations of these and/or other data, information, user input, etc.) to the application e.g. on the hosting server(s), etc. The hosting server(s) may, for example, respond by sending output (e.g. screen updates, text, video, audio, signals, code, data, information, etc.) to the user device. A sandbox may, for example, isolate (e.g. insulate, separate, divide, etc.) one or more applications, programs, software, etc. For example, an OS may place an application (e.g. code, preferences, configuration, data, etc.) in a sandbox (e.g. at install time, at boot, or any time). A sandbox may, for example, include controls that may limit the application access (e.g. to files, preferences, network, hardware, firmware, other applications, etc.). As part of the sandbox process, technique, etc. an OS may, for example, install one or more applications in one or more separate sandbox directories (e.g. repositories, storage locations, etc.) that may store the application, application data, configuration data, settings, preferences, files, and/or other information, etc.

Devices may, for example, be protected from accidental faults (e.g. programming errors, bugs, data corruption, hardware faults, network faults, link faults, etc.) or malicious (e.g. deliberate, etc.) attacks (e.g. virus, malware, denial of service attacks, root kits, etc.) by various security, safety, protection mechanisms etc. For example, CPUs etc. may include one or more protection rings (or just rings, also hierarchical protection domains, domains, privilege levels, etc.). A protection ring may, for example, include one or more hierarchical levels (e.g. logical layers, etc.) of privilege (e.g. access rights, permissions, gating, etc.). For example, an OS may run (e.g. execute, operate, etc.) in a protection ring. Different protection rings may provide different levels of access (e.g. for programs, applications, etc.) to resources (e.g. hardware, memory, etc.). Rings may be arranged in a hierarchy ranging from the from most privileged ring (e.g. most trusted ring, highest ring, inner ring, etc.) to the least privileged ring (e.g. least trusted ring, lowest ring, outer ring, etc.). For example, ring 0 may be a ring that may interact most directly with the real hardware (e.g. CPU, memory, I/O devices, etc.). For example, in a machine without virtualization, ring 0 may contain the OS, kernel, etc; ring 1 and ring 2 may contain device drivers, etc; ring 3 may contain user applications, programs, etc. For example, ring 1 may correspond to kernel space (e.g. kernel mode, master mode, supervisor mode, privileged mode, supervisor state, etc.). For example, ring 3 may correspond to user space (e.g. user mode, user state, slave mode, problem state, etc.). There is no fundamental restriction to the use of rings and, in general, any ring may correspond to any type of space, etc.

One or more gates (e.g. hardware gates, controls, call instructions, other hardware and/or software techniques, etc.) may be logically located (e.g. placed, situated, etc.) between rings to control (e.g. gate, secure, manage, etc.) communication, access, resources, transition, etc. between rings e.g. gate the access of an outer ring to resources of an inner ring, etc. For example, there may be gates or call instructions that may transfer control (e.g. may transition, exchange, etc.) to defined entry points in lower-level rings. For example, gating communication or transitions between rings may prevent programs in a first ring from misusing resources of programs in a second ring. For example, software running in ring 3 may be gated from controlling hardware that may only be controlled by device drivers running in ring 1. For example, software running in ring 3 may be required to request access to network resources that may be gated to software running in ring 1.

One or more coupled devices may form a collection, federation, confederation, assembly, set, group, cluster, etc. of devices. A collection of devices may perform operations, processing, computation, functions, etc. in a distributed fashion, manner, etc. In a collection etc. of devices that may perform distributed processing, it may be important to control the order of execution, how updates are made to files and/or databases, and/or other aspects of collective computation, etc. One or more models, frameworks, etc. may describe, define, etc. the use of operations etc. and may use a set of definitions, rules, syntax, semantics, etc. using the concepts of transactions, tasks, composable tasks, noncomposable tasks, etc.

For example, a bank account transfer operation (e.g. a type of transaction, etc.) might be decomposed (e.g. broken, separated, etc.) into the following steps: withdraw funds from a first account one and deposit funds into a second account.

The transfer operation may be atomic. For example, if either step one fails or step two fails (or a computer crashes between step one and step two, etc.) the entire transfer operation should fail. There should be no possibility (e.g. state, etc.) that the funds are withdrawn from the first account but not deposited into the second account.

The transfer operation may be consistent. For example, after the transfer operation succeeds, any other subsequent transaction should see the results of the transfer operation.

The transfer operation may be isolated. For example, if another transaction tries to simultaneously perform an operation on either the first or second accounts, what they do to those accounts should not affect the outcome of the transfer option.

The transfer operation may be durable. For example, after the transfer operation succeeds, if a computer should fail etc, there may be a record that the transfer took place.

The terms tasks, transactions, composable, noncomposable, etc. may have different meanings in different contexts (e.g. with different uses, in different applications, etc.). One set of frameworks (e.g. systems, applications, etc.) that may be used, for example, for transaction processing, database processing, etc. may be languages (e.g. computer languages, programming languages, etc.) such as structured transaction definition language (STDL), structured query language (SQL), etc.

For example, a transaction may be a set of operations, actions, etc. to files, databases, etc. that must take place as a set, group, etc. For example, operations may include read, write, add, delete, etc. All the operations in the set must complete or all operations may be reversed. Reversing the effects of a set of operations may roll back the transaction. If the transaction completes, the transaction may be committed. After a transaction is committed, the results of the set of operations may be available to other transactions.

For example, a task may be a procedure that may control execution flow, delimit or demarcate transactions, handle exceptions, and may call procedures to perform, for example, processing functions, computation, access files, access databases (e.g. processing procedures) or obtain input, provide output (e.g. presentation procedures).

For example, a composable task may execute within a transaction. For example, a noncomposable task may demarcate (e.g. delimit, set the boundaries for, etc.) the beginning and end of a transaction. A composable task may execute within a transaction started by a noncomposable task. Therefore, the composable task may always be part of another task's work. Calling a composable task may be similar to calling a processing procedure, e.g. based on a call and return model. Execution of the calling task may continue only when the called task completes. Control may pass to the called task (possibly with parameters, etc.), and then control may return to the calling task. The composable task may always be part of another task's transaction. A noncomposable task may call a composable task and both tasks may be located on different devices. In this case, their transaction may be a distributed transaction. There may be no logical distinction between a distributed and nondistributed transaction.

Transactions may compose. For example, the process of composition may take separate transactions and add them together to create a larger single transaction. A composable system, for example, may be a system whose component parts do not interfere with each other.

For example, a distributed car reservation system may access remote databases by calling composable tasks in remote task servers. For example, a reservation task at a rental site may call a task at the central site to store customer data in the central site rental database. The reservation task may call another task at the central site to store reservation data in the central site rental database and the history database.

The use of composable tasks may enable a library of common functions to be implemented as tasks. For example, applications may require similar processing steps, operations, etc. to be performed at multiple stages, points, etc. For example, applications may require one or more tasks to perform the same processing function. Using a library, for example, common functions may be called from multiple points within a task or from different tasks.

The terms that are explained, described, defined, etc. here and other related terms in the fields of systems design may have different meanings depending, for example, on their use, context, etc. For example, task may carry a generic or general meaning encompassing, for example, the notion of work to be done, etc. or may have a very specific meaning particular to a computer language construct (e.g. in STDL or similar). For example, the term transaction may be used in a very general sense or as a very specific term in a computer program or computer language, etc. Where confusion may arise over these and other related terms, further clarification may be given at their point of use herein.

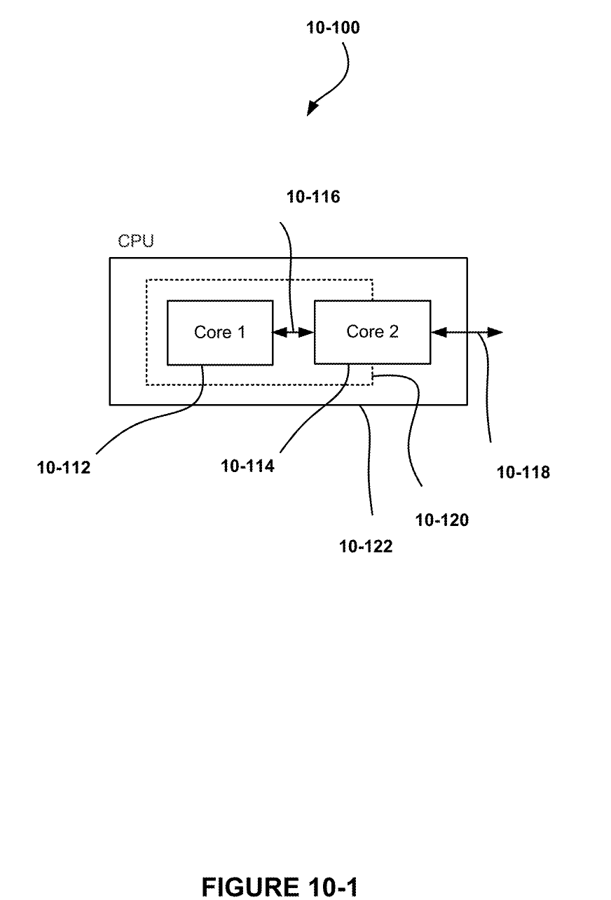

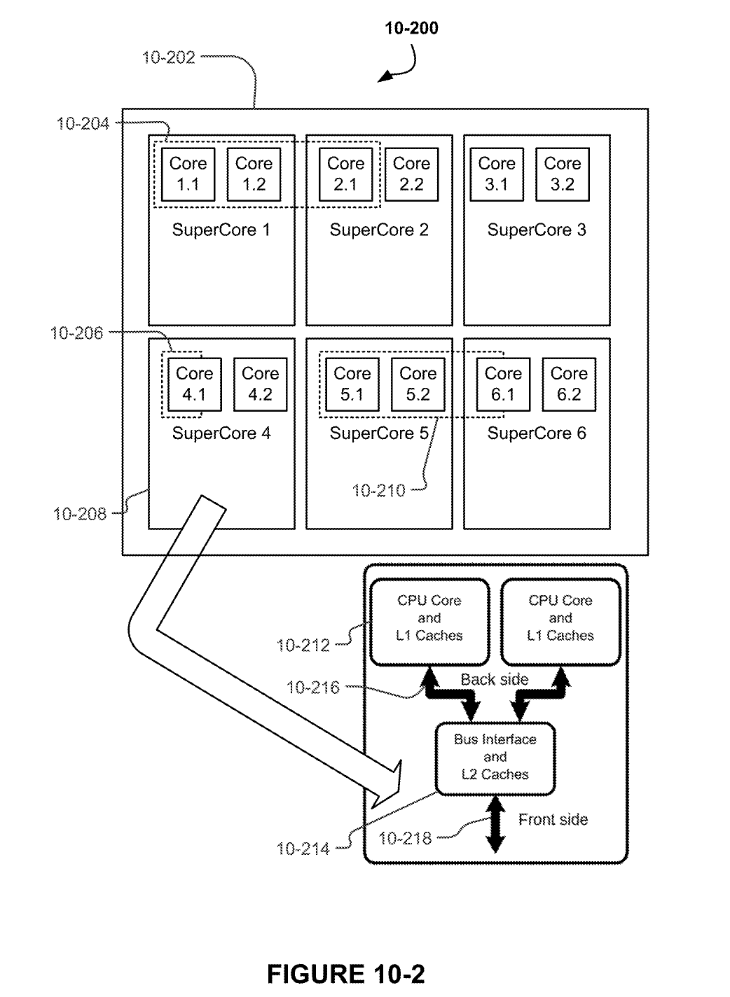

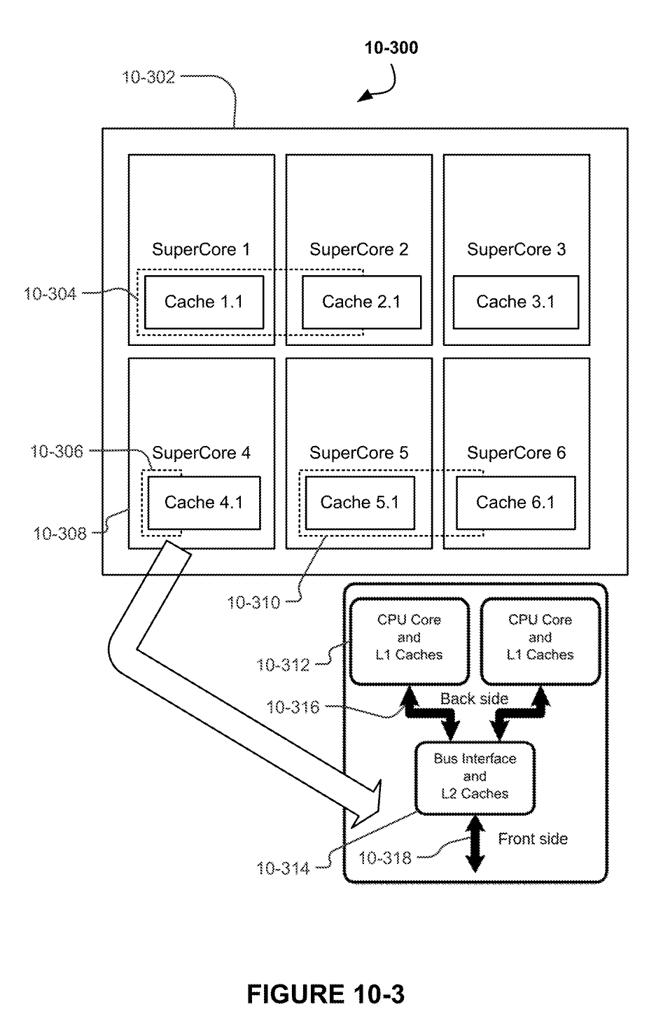

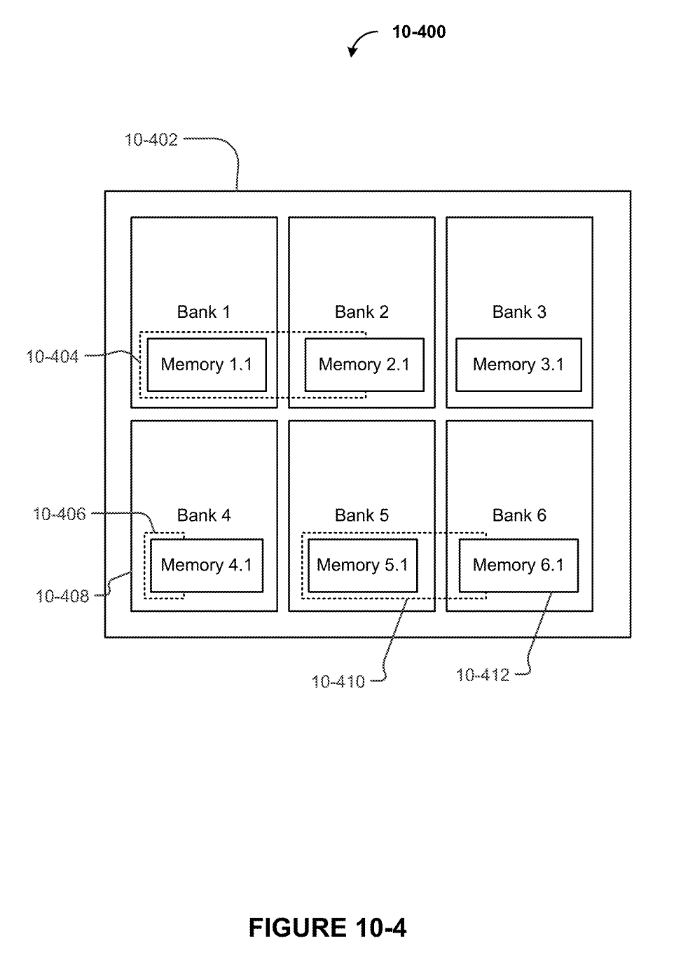

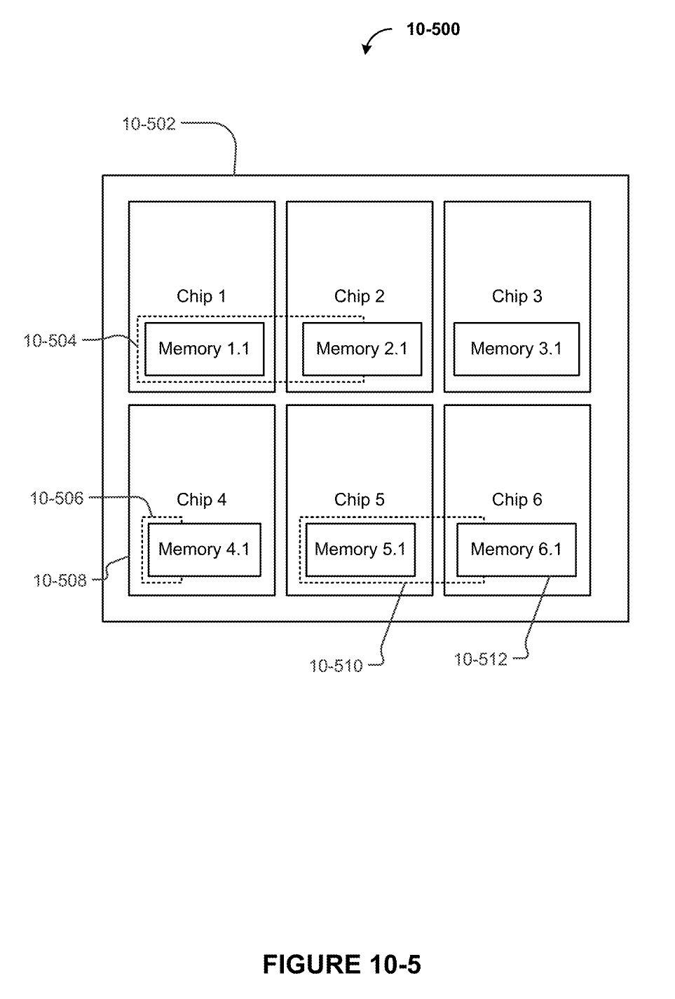

### FIG. 10-1A Fractionalization of Multi-Core CPUs

FIG. 10-1A shows a system 10-100, in accordance with one embodiment. As an option, the system 10-100 may be implemented in the context of any subsequent Figure(s). Of course, however, the system 10-100 may be implemented in the context of any desired environment. It should also be noted that the aforementioned definitions may apply during the present description.

As shown, the system 10-100 includes a CPU 10-122.

The CPU may contain a first core, Core 1, 10-112.

The CPU may contain a second core, Core 2, 10-114.

The CPU may contain etc. a first bus 10-116 that may allow, permit, etc. connection, communication etc. between, from, to, etc. cores that may be present in the CPU.

The CPU may include, contain, expose, etc. a second bus 10-118 that may allow, permit, etc. connection, communication etc. between, from, to, etc. one or more CPUs and/or other system components etc.

The CPU may include, contain, expose, etc. a group, collection, set, cluster, etc. of fractional cores 10-120. For example, in FIG. 10-1A, in one embodiment, a group of fractional cores may include all of Core 1 and a part, portion, fraction, etc. of Core 2.

### Fractionalization of Multi-Core and Memory System via Virtualization

The low utilization of Multi-Core Processors (MCPs) is a major drawback of symmetric MCPs. For example, low utilization may lead to inefficiency particularly with respect to power efficiency. For example, design inflexibility forces continuous leakage current in the unloaded and stand-by sub-elements, such as Sub-Processing Element (SPE), so that the power is wasted.

For example, in a symmetric MCP, there may be a Main Processing Element (MPE) and 8 SPEs. In many cases, only a portion of SPEs are utilized and the overall MCP utilization is usually low. Such stand-by SPEs consume high levels of power and continuously leak. Typically, a MCP is used for the high performance digital processor scaling, but due to the complexity of the MCP design, the utilization and the efficiency of the software become challenging to optimize as the MCP dimension increases.

In order to improve efficiency of MCPs this specification describes the fractionalization of multi-core systems and memory systems using virtualization techniques.

The fractionalization of multi-core systems and memory systems may be performed in several ways, using several techniques, using several architectures, combinations of these and the like, etc. including (but not limited to) one or more of the following techniques, methods, architectures, systems, etc.

(1) Fractionalize a group of cores: e.g. a group of homogeneous and/or heterogeneous architecture cores configured to be fractional cores (e.g. a group of ARM1, ARM2, ARM3, ARM4, ARM5, ARM6, ARM7, ARM8, etc. cores may be configured as fractional cores).

(2) Fractionalize a group of memories

(3) Fractionalize a group of memory modules

(4) Fractionalize a group of memory cells

(5) Fractionalize a group of L2 caches

In one embodiment for example, a system may be included in one or more CPUs, in one or more cores, fractions of cores, etc. for characterizing fractional virtualization in cores, caches, memory systems, IO circuits (e.g. peripheral, network, disk, storage, and the like etc.), in combinations of these and the like etc.

In one embodiment for example, a fractional address translation table (FDAT) may be embedded into one or more function blocks within, attached to, corresponding to, servicing, etc. one or more CPUs, cores, fractional cores, combinations of any of these and the like etc.

In one embodiment for example, fractional multi-core virtualization may be based, constructed, architected, etc. on one or more fractional functional blocks, fractional cores, fractional IO circuits, etc, combinations of any of these and the like etc.

In one embodiment for example, fractional virtualization may include, utilize, employ, etc. one or more fractional cache controllers, fractional memory controllers, fractional storage (e.g. SSD, hard disk, storage array(s), other storage, other memory, combinations of these and the like etc.), fractional storage controllers, other fractional IO controllers, combinations of any of these and the like etc.

In one embodiment for example, a fractional function block (e.g. a fractional core, fractional memory, fractional cache, combinations of any of these and the like etc.) and system may be operable to, may be capable of, may function as, may operate to, etc perform, execute, allow, permit, etc. one or more of the following steps, functions, operations, processes, etc.

1. Receiving a request (e.g. data, packet, command, instruction, combinations of any of these and the like etc.) e.g. from an initiator. In one embodiment for example, the initiator may be, for example, a processor, other fractional function block, other system component, network, bus, etc.

2. Selecting from an operation model, cache model, cache behavior, system behavior, etc. (e.g. for cache access, cache fetching etc.). In one embodiment for example, such a model may be unique, special, customized, etc. for systems that contain fractional blocks. In one embodiment for example, such a model may thus be (or be referred to as) a fractional cache model, etc.

3. Translating one or more addresses. In one embodiment for example, translation, mapping, etc. operations may involve translating one or more virtual addresses that may be (or be referred to as), for example, fractional virtual addresses to one or more physical addresses that may be (or be referred to as), for example, fractional physical addresses

4. Returning a response. In one embodiment for example, one or more responses (e.g. data, packets, information, status, state, flags, errors, etc.) may be returned to a sender, central resource, an initiator, etc. In one embodiment for example, one or more responses may be returned via a fractional memory controller

5. Processing the data request. In one embodiment for example, processing may be performed via a main memory processing element etc.

Although, the concept of fractional virtualization has been described above as the fractionalization, partitioning, portioning, apportioning, assignment, connection, etc. of one or more simple cores and/or other functional blocks within, for example, a multi-core CPU and/or system containing, including, etc. one or more multi-core CPUs, other implementations, architectures, constructions, etc. are contemplated within the scope of this specification.

In one embodiment for example, nested cores may be contained, included, etc. inside, within, as part of, etc. one or more CPUs.

In one embodiment for example, nested structures may be contained, included, etc. inside, within, as part of, etc. one or more blocks, circuits, components, etc. that are outside (including partially outside, or connected to, or in communication with, networked to, etc.) one or more CPUs.

In one embodiment for example, the use of one or more nested structures, circuits, blocks, cores, caches, memories, etc. may lead to the concept, idea, etc. of fractions of fractionalized resources.

In one embodiment for example, the use of one or more fractionalized structures, circuits, blocks, cores, caches, memories, etc. may lead to the use, concept, idea, etc. of fractional software. In one embodiment for example, fractional software may operate, use, employ, etc. fractional devices, fractional CPUs, fractional hardware and/or any fractional resource, combination of fractional resources and the like, etc.

In one embodiment for example, fractional software may operate, use, employ, etc. one or more database operations etc. using factional or factionalized hardware. In one embodiment for example, such fractional software may be used to perform operations etc. on a fractionalized database.

In one embodiment for example, such fractional database software may perform, or be operable to perform, etc. atomic mappings to, atomic operations on fractional devices, fractional hardware, etc. Such mapping of atomic behavior etc. to fractional function blocks may help to ensure, for example, that a set of tasks is completed in isolation etc. from other tasks. For example, a first task or set of tasks may be mapped etc. to a first group etc. of fractionalized functions and a second task, set of tasks, etc. may be mapped to a second group etc. of fractionalized functions. Such tasks etc. may be database operations, but are not limited to database operations.

In one embodiment for example, such use of fractional hardware, fractional functions etc. to perform one or more fractional software functions (e.g. atomic operations, isolated operations, etc.). In one embodiment for example, such use of fractional hardware, fractional functions etc. to perform one or more fractional software functions may be used to calculate, perform etc. one or more results of one or more asynchronous operations.

In one embodiment for example, such use of fractional software functions may be used with software constructs such as promises. A promise (e.g. in JavaScript, etc.) may represent the eventual result of an asynchronous operation. The primary way of interacting with a promise is through its then method, which registers callbacks to receive either the a eventual value of a promise or the reason why the promise cannot be fulfilled.

In one embodiment for example, such use of fractional software functions may permit, allow, etc. a parallel, mapping, compiling, etc. between one or more atomic operations (e.g. as groups of operations, statements, processes, functions and the like etc.) and sets or groups of operations that may be performed, executed, etc. on fractional devices, fractional resources, etc.

In one embodiment for example, such use of fractional software functions may force, enforce, guarantee, allow, permit, etc. the execution, performance, etc. of one or more atomic operations (or similar functions, groups of functions, etc. that may have time value, ACID properties, other similar requirements, properties, and the like etc.) by mapping to a fractional system or fractionalized system. Such systems may lead to the concept of fractionalized atomic systems or alternatively be referred to as atomic fractionalized systems, since the system may be fractionalized but is behaving in an atomic etc. fashion, manner, etc. In one embodiment for example, such use of an atomic fractionalized systems may allow the atomic behavior of a fractionalized system.

In one embodiment for example, such use of an atomic fractionalized systems may improve the efficiency of big data systems (also Big Data etc.), database operations, lookup, tables, distributed database system, and the like etc.

In one embodiment for example, such use of an atomic fractionalized systems may improve the efficiency of software frameworks for distributed storage, distributed processing, etc.

In one embodiment for example, such use of an atomic fractionalized systems may improve the efficiency of software such as Apache Hadoop etc. Hadoop is an open-source software framework for distributed storage and distributed processing of Big Data on clusters of commodity hardware. The Hadoop Distributed File System (HDFS) splits files into large blocks (e.g. 64 MB or 128 MB) and distributes the blocks amongst nodes e.g. in a Hadoop cluster. To process the data, the Hadoop Map/Reduce function ships code (e.g. Jar files) to the nodes that have the required data, and the nodes then process the data in parallel. In one embodiment for example, an atomic fractionalized systems may map, partition, fractionalize resources to map one or more fractional resources e.g. to nodes in a Hadoop cluster etc.

In one embodiment for example, a fractionalized systems may improve the reliability, availability, serviceability, and other similar RAS functions of both hardware and/or software functions of a system.

In one embodiment for example, a fractionalized system may be used to implement an ultra-reliable system. In one embodiment for example, an ultra-reliable system may use majority voting of fractional cores, and/or other fractional resources, etc. to ensure that no failures of one or more fractional resources may result in system failure, erroneous system behavior etc.

In one embodiment for example, a fractionalized system using may include the use fractional memory for fail-safe, snapshots, store and recover, mirroring and other functions.

In one embodiment for example, a fractionalized system may be used to improve the yield of large die (e.g. CPU die, etc.). In one embodiment for example, only 3 of 4 fractions need to work on a core for the core to be used.

Although, the description of fractional virtualization above has included the static, semi-static, configured, etc. use of fractionalization, partitioning, portioning, apportioning, assignment, connection, etc. of one or more simple cores and/or other functional blocks within, for example, a multi-core CPU and/or system containing, including, etc. one or more multi-core CPUs, other dynamic, changing, reconfigurable, etc. implementations, architectures, constructions, etc. are contemplated within the scope of this specification.

In one embodiment for example, a fractionalized system may be used to permit, allow, enable, etc. collaborating functions, collaborating fractions, collaboration of resources, etc. In one embodiment for example, a first fraction, Fraction 1, may be busy (or used, occupied, broken, asleep, etc.) but one (or more) other fractions e.g. Fractions 2 plus 3 (not necessarily same as Fraction 1) may be used as a fractional substitute, fractional alternative, etc. In this case, for example, fractions (e.g. Fraction 2 and Fraction 3) may be used, employed, configured, reconfigured, changed, modified, altered, programmed, reprogrammed, etc. as one or more collaborative fractions e.g. to replace, substitute for, etc. all or part of another fraction e.g. Fraction 1.

In one embodiment for example, Fractions 2 plus 3 may only be used for a part of the function of Fraction 1. In this case, for example, Fractions 2 plus 3 may be used for a part of the task etc. assigned to Fraction 1. In one embodiment for example, the fractional assignment or assignment of fractions may vary with time, etc. Thus, for example, in a first situation, scenario, configuration, time period, etc. it may be optimum to assign the function etc. of Fraction 1 to Fractions 2 plus 3, while in a second situation, scenario, configuration, time period, etc. it may be optimum to assign the function etc. of Fraction 1 to Fractions 3 plus 4, etc.

In one embodiment for example, a fractionalized system may be used to permit, allow, enable, etc. fractional compilation. For example, a Java VM may use JIT compilation. In this case, there may be two parts of the compiler that perform one or more similar compilation functions (but not necessarily at the same time, e.g. one at compile time and one a run time etc.). In one embodiment for example, a fractionalized system may be used to perform fractional compilation by using a first fraction, set of fractions, etc. to perform a first compilation step (e.g. at compile time) and a second fraction, set of fractions, etc. to perform a second compilation step (e.g. at run time).

In one embodiment for example, such fractional compilation and/or other forms of fractional computation may be mapped to a cluster, collection of devices, Hadoop cluster, one or more virtual machines, etc.

In one embodiment for example, the use of a fractionalized systems, fractionalized software, and fractional computation in general leads to concept of fractional devices. Thus a possibly dynamic collection, group, etc. of fractional resources (e.g. cores, caches, memories, storage, other systems components, combinations of these and the like etc.) may be used as one or more fractional devices.

In one embodiment for example, the use of a fractionalized systems, fractionalized software, and fractional computation in general leads to concept of elastic systems. Thus a possibly dynamic collection, group, etc. of fractional resources (e.g. cores, caches, memories, storage, other systems components, combinations of these and the like etc.) may be used as one or more elastic systems that may be altered in size, scope, function, or any other aspect, form and the like etc. Thus, for example, the use of elastic systems may adapt, may be controlled, may be adjusted, etc. continually, in steps, permanently, at start-up, during operation, at manufacturing time, at test time, or at combinations of these times, or at any time.

The fractional inventions and process of fractionalization described herein allow important types of new and novel behavior at the micro and macro levels. At the macro level, the inventions perform virtualization of fractional components to enable new functions and functional behavior (including, for example, increased system efficiency, increased reliability, increased flexibility, etc. as well as reduced cost, etc.). At the micro level, a sensor, circuit or other similar function (referred to as an O-ring) may partition a group of circuits, blocks, etc. and use one or more of these as a fraction, a function (e.g. a cell, similar to a brain cell in concept and function). The fractions may be coupled, may communicate, may be connected etc. using a network, mesh network, wired network, packet network, etc. The fractional approach described herein may reduce power consumption as unused fraction may be put into power-saving modes, tasks may be assigned, scheduled, etc. more efficiently to different fractions, etc. The fractional virtualization described herein allows the fractions, their configuration, connection and operation to change dynamically.

### FIG. 10-2 Fractional Virtual Cores

FIG. 10-2 shows a system 10-200, in accordance with one embodiment. As an option, the system 10-200 may be implemented in the context of any subsequent Figure(s). Of course, however, the system 10-200 may be implemented in the context of any desired environment. It should also be noted that the aforementioned definitions may apply during the present description.

As shown, the system 10-200 may include a CPU 10-202. The system 10-200 may contain a number of components, described below.

Component 10-204 may be a first type of virtualized core (or just virtual core or VC) comprising three cores. Any number of cores may be used in a VC.

Component 10-206 may be a second type of VC comprising a fractional core or FC. Any fraction of a core may be used in a VC. Any number of FCs may be used in a VC. Any type of FC may be used in a VC. Any type of separation (e.g. partitioning, fractionalization, portioning, apportioning, assignment of resources, etc.) may be used to form an FC. Separation may be dynamic. Separation may be static. Separation may be configured, changed, manipulated, etc. in any way.

Component 10-208 may be a supercore or SC comprising two cores. Any number of cores may be used to form an SC. Any type of cores may be used to form an SC. Cores within a SC may be of any type. Cores within a SC may be of any architecture, based on any instruction set, etc. Cores within a SC may be of any construction. Cores within a SC may be of any number.

Component 10-210 may be a third type of VC comprising two cores and one VC. Any number, type, construction, architecture, separation, etc. of cores and/or VCs may be used.

Component 10-212 may be a CPU core. The CPU core may be of any type, construction, architecture, etc.

Component 10-214 may be a circuit that performs one of more auxiliary and/or ancillary functions, helper functions, acceleration functions, co-processing functions, behaviors, etc. to one of more CPU cores. For example, circuit 10-214 may perform one or more bus interface functions, may contain one or more caches e.g. L2 cache, etc.

Bus 10-216 may be a back-side bus. (BSB). The BSB may use any type of signaling, may use packets, may be a networked bus, may be a high-speed serial bus, may use any type of protocol, etc.

Bus 10-218 may be a front-side bus. (FSB). The FSB may use any type of signaling, may use packets, may be a networked bus, may be a high-speed serial bus, may use any type of protocol, etc. In other embodiments, the connection, architecture, use, function, etc. of the BSB and FSB may be slightly different from that shown, but the functions, behavior, purpose, use, operation, etc. Of the BSB and/or FSB may be largely similar to that shown.

In one embodiment for example, the SCs may be all of one type, class, form, architecture, structure, construction etc. In one embodiment for example, one or more SCs may have one or more aspects that are different, modified, altered, configured, etc. In one embodiment for example, an aspect may be an architecture e.g. instruction set, etc. In one embodiment for example, an aspect may be a physical parameter, e.g. operating speed. In one embodiment for example, an aspect may be an electrical parameter, e.g. operating voltage. In one embodiment for example, an aspect may be any aspect, feature, parameter, specification, facet, function, behavior, physical property, electrical property, combination(s) of any of these and the like etc. In one embodiment for example, the CPU may be a homogeneous collection, array, grouping, set, etc. of cores. In one embodiment for example, the CPU may be a heterogeneous collection, array, grouping, set, etc. of cores.

In one embodiment for example, similarly the FCs and VCs that are comprised from FCs may be, and/or may form, be configured, be tailored, etc. as a homogeneous array or a heterogeneous array. In one embodiment for example, FCs in a homogeneous CPU array may be configured to form a homogeneous array of VCs. In one embodiment for example, a homogeneous CPU array may be configured to a lower power mode by re-configuring all the cores to a similar lower-power state, configuration etc. In one embodiment for example, a fraction, subset, etc. of the cores in a homogeneous array may be configured etc. to a low-power state, thus forming, in this case, a heterogeneous array from a homogeneous array. Such configuration etc. of cores, VCs, FCs, etc. need not be to a low-power state, any type of aspect, any number of aspects, etc. may be configured. In one embodiment for example, operating frequency, supply voltage(s), pipeline behavior and functions, datapaths, and/or any circuit, sub-circuit behaviors, functions, etc. of any core, FC, VC, SC, or combinations of these etc. may be altered, changed, configured, modified, manipulated, controlled, etc.

### FIG. 10-3 Fractional Virtual Cache Memory

FIG. 10-3 shows a system 10-300, in accordance with one embodiment. As an option, the system 10-300 may be implemented in the context of any subsequent Figure(s). Of course, however, the system 10-300 may be implemented in the context of any desired environment. It should also be noted that the aforementioned definitions may apply during the present description.

As shown, the system 10-300 includes a CPU 10-302. System 10-300 may comprise a number of components described below.

Component 10-304 may be a first type of virtualized cache (or just virtual cache or V$) comprising three caches. Any number of caches may be used in a V$.

Component 10-306 may be a second type of V$ comprising a fractional cache or F$. Any fraction of a core may be used in a V$. Any number of F$s may be used in a V$. Any type of F$ may be used in a V$. Any type of separation may be used to form an F$. Separation may be dynamic. Separation may be static. Separation may be configured.

Component 10-308 may be a SC comprising two cores. Any number of cores may be used to form an SC. Any type of cores may be used to form an SC. Cores within a SC may be of any type. Cores within a SC may be of any architecture. Cores within a SC may be of any construction. Cores within a SC may be of any number.

Component 10-310 may be a third type of V$ comprising two caches and one V$. Any number, type, construction, architecture, separation, etc. of caches and/or V$s may be used.

Component 10-312 may be a CPU core. The CPU core may be of any type, construction, architecture, etc.

Component 10-314 may be a circuit that performs one of more auxiliary and/or ancillary functions, behaviors, etc. to one of more CPU cores. For example, circuit 10-314 may perform one or more bus interface functions, may contain one or more caches e.g. L2 cache etc.

Bus 10-316 may be a back-side bus. (BSB).

Bus 10-318 may be a front-side bus. (FSB).

In one embodiment for example, one or more of the components, buses, etc. shown in FIG. 10-3 may be similar in function to corresponding and/or similar components, buses, etc. shown in FIG. 10-2.

### FIG. 10-4 Fractional Memory Module

FIG. 10-4 shows a system 10-400, in accordance with one embodiment. As an option, the system 10-400 may be implemented in the context of any subsequent Figure(s). Of course, however, the system 10-400 may be implemented in the context of any desired environment. It should also be noted that the aforementioned definitions may apply during the present description.

As shown, the system 10-400 includes a memory system 10-402. In one embodiment for example, the system 10-400 may comprise one or more components, etc. described below.

In one embodiment, for example, component 10-402 may be a memory module, collection of memory modules, or one or more portions of one or more memory modules.

Component 10-404 may be a first type of virtualized memory module.

Component 10-406 may be a second type of virtualized memory module.

Component 10-408 may be a bank of memory. The term bank may be used in other contexts. Here bank is any collection, grouping, set, etc. of memory resources. In one embodiment, for example, a memory bank may be a memory module, collection of memory modules, or one or more portions of a memory module.

Component 10-410 may be a third type of virtualized memory module.

Component 10-412 may be a memory unit, memory resource, or some other type of grouping, collection, set, circuits etc. of memory. For example a memory unit may be a collection of dynamic memory circuits. For example a memory unit may be a collection of embedded memory circuits. For example a memory unit may be a collection of static memory circuits. For example a memory unit may be a collection of memory devices, memory chips, stacked memory chips, fractions of a memory chip, fractions of a stacked memory package, one or more DIMMs, one of more fractions (e.g. ranks, etc.) of one or more DIMMs, and/or any combinations of these and/or portions of these, etc. Different types, technologies (e.g. DRAM, NAND, SRAM, etc.) may be present in a single memory unit, or in different memory units.

In one embodiment, for example, component 10-412 may be a memory module, collection of memory modules, or one or more portions of one or more memory modules.

In one embodiment, for example, N memory units may be virtualized to M virtualized memory modules.

In one embodiment, for example, memory virtualization may be static or dynamic.

For example, in one embodiment, component 10-402 may represent a single virtual memory module that may comprise N physical memory modules. In this case, for example, a memory module may correspond to a bank 10-408, though this need not always be the case. The single virtual memory module may be reconfigured dynamically to, for example, four fractional memory modules. The functions and behavior of the single virtual memory module may be reconfigured to, for example, 1-N fractional memory modules.

In one embodiment, for example, N physical memory modules may be located on one or more memory cards that form all or part of a memory system.

### FIG. 10-5 Fractional Memory

FIG. 10-5 shows a system 10-500, in accordance with one embodiment. As an option, the system 10-500 may be implemented in the context of any subsequent Figure(s). Of course, however, the system 10-500 may be implemented in the context of any desired environment. It should also be noted that the aforementioned definitions may apply during the present description.

As shown, the system 10-500 includes a memory system or memory sub-system 10-502.

In one embodiment, for example, memory system or memory sub-system 10-502 may be a memory module corresponding to a memory module as described in relation to FIG. 10-4.

In one embodiment, for example, memory system or memory sub-system 10-502 may comprise a collection, set, group, etc. of memory chips, stacked memory chips, memory circuits, combinations of these, fractions of these, and/or any combination, grouping etc. of any of these.

In one embodiment, for example, memory system or memory sub-system 10-502 may comprise a number of components described below.

Component 10-504 may be a first type of virtualized memory cell.(VMC).

Component 10-506 may be a second type of VMC

Component 10-508 may be a memory chip. The term memory chip may be used in other contexts. Here memory chip is any collection, grouping, set, etc. of memory resources, circuits, packages, etc.

Component 10-510 may be a third type of VMC.

Component 10-512 may be a memory unit, memory resource, or some other type of grouping, collection, set, circuits etc. of memory. For example a memory unit may be a collection of dynamic memory circuits. For example a memory unit may be a collection of embedded memory circuits. For example a memory unit may be a collection of static memory circuits. For example a memory unit may be a collection of memory devices, memory chips, stacked memory chips, fractions of a memory chip, fractions of a stacked memory package, one or more DIMMs, one of more fractions (e.g. ranks, etc.) of one or more DIMMs, and/or any combinations of these and/or portions of these, etc. Different types, technologies (e.g. DRAM, NAND, SRAM, etc.) may be present in a single memory unit, or in different memory units.

In one embodiment, for example, 10-512 may be equivalent to the memory unit as described in relation to FIG. 10-4, though it need not ne. For example, in one embodiment, 10-512 may be a subset of the memory unit as described in relation to FIG. 10-4.

In one embodiment, for example, 32 memory cells may be virtualized into a single virtual memory module.

In one embodiment, for example, a single virtual memory module may be dynamically reconfigured to 7 fractional memory cells based on functionality required. For example the allocation may be to 4, 2, 4, 6, 10, 4, 2 memory cells.

It may thus be seen from the examples provided above that the improvements to devices (e.g. as shown in the contexts of the Figures included in this specification, for example) may be used in various applications, contexts, environments, etc., including artificial intelligence (AI). The applications, uses, etc. of these improvements etc. may not be limited to those described above, but may be used, for example, in combination. For example, one or more applications etc. used in the contexts, for example, in one or more Figures may be used in combination with one or more applications etc. used in the contexts of, for example, one or more other Figures and/or one or more applications etc. described in any specifications incorporated by reference.

It should be noted that, one or more aspects of the various embodiments of the present invention may be included in an article of manufacture (e.g., one or more computer program products) having, for instance, computer usable media. The media has embodied therein, for instance, computer readable program code for providing and facilitating the capabilities of the various embodiments of the present invention. The article of manufacture can be included as a part of a computer system or sold separately.

Additionally, one or more aspects of the various embodiments of the present invention may be designed using computer readable program code for providing and/or facilitating the capabilities of the various embodiments or configurations of embodiments of the present invention.

Additionally, one or more aspects of the various embodiments of the present invention may use computer readable program code for providing and facilitating the capabilities of the various embodiments or configurations of embodiments of the present invention and that may be included as a part of a computer system and/or memory system and/or sold separately.

Additionally, at least one program storage device readable by a machine, tangibly embodying at least one program of instructions executable by the machine to perform the capabilities of the various embodiments of the present invention can be provided.

The diagrams depicted herein are just examples. There may be many variations to these diagrams or the steps (or operations) described therein without departing from the spirit of the various embodiments of the invention. For instance, the steps may be performed in a differing order, or steps may be added, deleted or modified. All of these variations are considered a part of the claimed invention.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein.

References in this specification and/or references in specifications incorporated by reference to “one embodiment” may mean that particular aspects, architectures, functions, features, structures, characteristics, etc. of an embodiment that may be described in connection with the embodiment may be included in at least one implementation. Thus references to “in one embodiment” may not necessarily refer to the same embodiment. The particular aspects etc. may be included in forms other than the particular embodiment described and/or illustrated and all such forms may be encompassed within the scope and claims of the present application.

References in this specification and/or references in specifications incorporated by reference to “for example” may mean that particular aspects, architectures, functions, features, structures, characteristics, etc. described in connection with the embodiment or example may be included in at least one implementation. Thus references to an “example” may not necessarily refer to the same embodiment, example, etc. The particular aspects etc. may be included in forms other than the particular embodiment or example described and/or illustrated and all such forms may be encompassed within the scope and claims of the present application.

This specification and/or specifications incorporated by reference may refer to a list of alternatives. For example, a first reference such as “A (e.g. B, C, D, E, etc.)” may refer to a list of alternatives to A including (but not limited to) B, C, D, E. A second reference to “A etc.” may then be equivalent to the first reference to “A (e.g. B, C, D, E, etc.).” Thus, a reference to “A etc.” may be interpreted to mean “A (e.g. B, C, D, E, etc.).”

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus, comprising:
a processing unit including a plurality of processing cores including a first processing core and a second processing core;
wherein the apparatus is configured such that a virtual processing core is capable of being virtualized utilizing at least a portion of the first processing core and at least a portion of the second processing core such that at least one of the at least portion of the first processing core or the at least portion of the second processing core includes only a part thereof;
wherein the apparatus is configured such that a fractional address translation table is embedded into one of the first processing core or the second processing core.

2. The apparatus of claim 1, wherein the processing unit includes a central processing unit.

3. The apparatus of claim 1, wherein the apparatus is configured such that at least one of the at least portion of the first processing core or the at least portion of the second processing core include a subset of circuits thereof.

4. The apparatus of claim 1, wherein the apparatus is configured such that at least one of the at least portion of the first processing core or the at least portion of the second processing core include a subset of functionality thereof.

5. The apparatus of claim 1, wherein the apparatus is configured such that the part includes a fractional part.

6. The apparatus of claim 1, wherein the apparatus is configured such that the apparatus is configured such that the virtual processing core is capable of being virtualized utilizing the at least portion of the first processing core and the at least portion of the second processing core such that both the at least portion of the first processing core and the at least portion of the second processing core include only a part thereof.

7. A computer program product embodied on a non-transitory computer readable medium, comprising:
code for cooperating with a processing unit including a plurality of processing cores including a first processing core and a second processing core;
wherein the computer program product is configured such that a virtual processing core is capable of being virtualized utilizing at least a portion of the first processing core and at least a portion of the second processing core such that at least one of the at least portion of the first processing core or the at least portion of the second processing core includes only a part thereof;
wherein the computer program product is configured such that a fractional address translation table is embedded into one of the first processing core or the second processing core.

8. The computer program product of claim 7, wherein the processing unit includes a central processing unit.

9. The computer program product of claim 7, wherein the computer program product is configured such that at least one of the at least portion of the first processing core or the at least portion of the second processing core include a subset of circuits thereof.

10. The computer program product of claim 7, wherein the computer program product is configured such that at least one of the at least portion of the first processing core or the at least portion of the second processing core include a subset of functionality thereof.

11. The computer program product of claim 7, wherein the computer program product is configured such that the part includes a fractional part.

12. The computer program product of claim 7, wherein the computer program product is configured such that the apparatus is configured such that the virtual processing core is capable of being virtualized utilizing the at least portion of the first processing core and the at least portion of the second processing core such that both the at least portion of the first processing core and the at least portion of the second processing core include only a part thereof.

13. A method, comprising:
cooperating with a processing unit including a plurality of processing cores including a first processing core and a second processing core;
wherein a virtual processing core is capable of being virtualized utilizing at least a portion of the first processing core and at least a portion of the second processing core such that at least one of the at least portion of the first processing core or the at least portion of the second processing core includes only a part thereof;
wherein a fractional address translation table is embedded into one of the first processing core or the second processing core.

14. The method of claim 13, wherein the processing unit includes a central processing unit.

15. The method of claim 13, wherein at least one of the at least portion of the first processing core or the at least portion of the second processing core include a subset of circuits thereof.

16. The method of claim 13, wherein at least one of the at least portion of the first processing core or the at least portion of the second processing core include a subset of functionality thereof.

17. The method of claim 13, wherein the part includes a fractional part.

18. The method of claim 13, wherein the virtual processing core is capable of being virtualized utilizing the at least portion of the first processing core and the at least portion of the second processing core such that both the at least portion of the first processing core and the at least portion of the second processing core include only a part thereof.
